(19) United States
(12) Patent Application Publication
(10) Pub. No.: US 2022/0250911 A1
(43) Pub. Date: Aug. 11, 2022

(54) METHOD FOR FORMING BLACK PHOSPHORUS

(71) Applicant: KOREA RESEARCH INSTITUTE OF STANDARDS AND SCIENCE, Daejeon (KR)

(72) Inventors: Jae Yong SONG, Daejeon (KR); Ho Sun SHIN, Daejeon (KR); Viet Chien NGUYEN, Daejeon (KR)

(21) Appl. No.: 17/623,749

(22) PCT Filed: Jul. 15, 2020
(86) PCT No.: PCT/KR2020/009304

§ 371 Date: Dec. 29, 2021

(30) Foreign Application Priority Data
Aug. 7, 2019 (KR) 10-2019-0096101

(51) Int. Cl. C01B 25/02

(52) U.S. Cl. CPC C01B 25/02; C01P 2006/40; C01P 2002/85; C01P 2004/03; C01P 2004/04; C01P 2002/72

(57) ABSTRACT

Provided is a method of forming black phosphorus (BP) with a high purity and a high electrical conductivity. The method includes the steps of performing a milling process and a sintering process on red phosphorus (RP) and adding tin (Sn) while performing a milling process and a sintering process on red phosphorus (RP).

### TECHNICAL FIELD

The present invention relates to a method of synthesizing black phosphorus (BP), and more particularly, to a simple method of synthesizing BP with a high purity and a high electrical conductivity.

### BACKGROUND ART

As one of various allotropes of phosphorus (P), black phosphorus (BP) is a new two-dimensional (2D) material with a tunable direct band gap, a high carrier mobility, and strong anisotropy and is widely applicable in various fields due to light weight, low toxicity, and high abundance thereof. However, despite the above advantages, a high production cost of BP and a low electrical conductivity of pristine BP are the largest obstacles to commercialization. Current BP synthesis methods include a method of inducing phase transformation of white phosphorus (WP) or red phosphorus (RP) at high temperature and high pressure and a chemical vapor transport method using catalytic reaction, but are not suitable for low-cost mass production. In addition, pristine BP has a high charge mobility of 1000 cm²V⁻¹s⁻¹ but has a low carrier concentration of 10¹⁵ cm⁻³ to 10¹⁷ cm⁻³ and thus may not be easily commercialized without an additional doping process.

### DETAILED DESCRIPTION OF THE INVENTION

### Technical Problem

The present invention provides a simple method of synthesizing black phosphorus (BP) with a high purity and a high electrical conductivity.

### Technical Solution

According to an aspect of the present invention, there is provided a method of synthesizing black phosphorus (BP) by adding tin (Sn) while performing a milling process and a sintering process on red phosphorus (RP).

Sn may be added before the sintering process, and a sintering temperature of the sintering process may be higher than or equal to a eutectic temperature of Sn and phosphorus (P).

A purity of BP may be relatively increased by an amount of Sn preferentially reacting with RP rather than BP in a molten alloy of Sn and P formed in the sintering process.

Sn may serve as a dopant in BP to relatively increase an electrical conductivity of BP in proportion to a carrier concentration.

When Sn is added by 1.5 wt %, RP may be completely crystallized into Sn-doped BP and an electrical conductivity of Sn-doped BP may be more than 16 times higher than an electrical conductivity of pristine BP.

When a content of added Sn exceeds a solubility of Sn dissolved in a BP matrix, an electrical conductivity of a composite of the BP matrix and a SnP₃ precipitate precipitated in the BP matrix may be relatively higher than the electrical conductivity of pristine BP.

When a content of added Sn is increased from 1 wt % to 10 wt %, an electrical conductivity of synthesized BP at 300K to 553K may be increased.

The milling process may include a high energy ball milling (HEBM) process, and the sintering process may include a spark plasma sintering (SPS) process.

### Advantageous Effects

According to an embodiment of the present invention, a simple method of synthesizing black phosphorus (BP) with a high purity and a high electrical conductivity may be implemented. However, the scope of the present invention is not limited to the above-described effect.

### DESCRIPTION OF THE DRAWINGS

FIG. 1 shows X-ray diffraction (XRD) patterns of sintered black phosphorus (BP) pellets based on various tin (Sn) contents.

FIG. 2 is a graph showing average grain sizes of sintered BP samples having various Sn contents after a spark plasma sintering (SPS) process.

FIG. 3 shows the shape, microstructure, and chemical composition of a BP sample in which 1.5 wt % of Sn is dissolved, and includes (a) a scanning electron microscope (SEM) image of a fracture surface with an image of the BP sample after being cut and abraded, (b) a high-resolution transmission electron microscope (HR-TEM) image showing a lattice spacing and a diffraction pattern of BP, (c) a scanning transmission electron microscope (STEM) image of Sn, and (d) an energy dispersive X-ray spectrometer (EDX) elemental map corresponding to Sn.

FIG. 4 shows a STEM-EDS spectrum of BP having 1.5 wt % of Sn.

FIG. 5 includes FIG. 5(a) a high-angle annular dark-field scanning transmission electron microscope (HAADF-STEM) image of BP having 10 wt % of Sn, FIG. 5(b) an EDX elemental map corresponding to Sn, and FIG. 5(c) a magnified HR-TEM image and a fast Fourier transform (FFT) result image of a red rectangle of (a).

FIG. 6 includes FIG. 6(a) a SEM image showing an interface between amorphous RP and crystalline BP, FIG. 6(b) an EDS elemental map, FIG. 6(c) a magnified image of an RP region, and FIG. 6(d) a magnified image of a BP region.

FIG. 7 shows XRD patterns of BP powder and pellets sintered with 5% of Sn at various temperatures.

FIG. 8(a) shows electrical conductivities of BP pellets based on Sn contents at temperatures from 300K to 553K and FIG. 8(b) the result of effective medium theory (EMT) calculation used to explain charge transportation in a composite material of BP and SnP₃.

FIG. 9 shows an electrical conductivity of SnP₃ based on temperature.

FIG. 10 shows variations of a carrier concentration and a mobility based on a Sn content at 300K.

### MODE OF THE INVENTION

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art.

Low-cost red phosphorus (RP) may be partially transformed into black phosphorus (BP) in a solid state through a ball milling process and a sintering process. When 1.5 wt % of tin (Sn) was added, RP was completely crystallized into Sn-doped BP and an electrical conductivity thereof was increased to 1,625 Sm⁻¹ at 300 K, which is about 16 times higher than the electrical conductivity of pristine BP, i.e., 100 Sm⁻¹. The mechanism of complete phase transformation from amorphous RP into crystalline BP and the enhancement in electrical properties due to the role of Sn as a p-type dopant will now be described.

As one of various allotropes of phosphorus (P), BP is a new two-dimensional (2D) material with a tunable direct band gap, a high carrier mobility, and strong anisotropy and is widely applicable in various fields due to light weight, low toxicity, and high abundance thereof. However, despite the above advantages, a high production cost of BP and a low electrical conductivity of pristine BP are the largest obstacles to commercialization. Current BP synthesis methods include a method of inducing phase transformation of white phosphorus (WP) or RP at high temperature and high pressure and a chemical vapor transport method using catalytic reaction, but are not suitable for low-cost mass production. In addition, pristine BP has a high charge mobility of 1000 cm²V⁻¹s⁻¹ but has a low carrier concentration of 10¹⁵ cm⁻³ to 10¹⁷ cm⁻³ and thus may not be easily commercialized without an additional doping process.

The present invention proposes a high energy ball milling (HEBM) process for implementing phase transformation from RP into BP by inducing high pressure during collision. The present invention also proposes a spark plasma sintering (SPS) process capable of phase-transforming from RP into BP and of increasing an electrical conductivity with the aid of Sn.

In the present invention, BP was synthesized through a 2-step HEBM (Spex 8000D Mixer/Mill) process and a SPS (Dr. Sinter-211Lx) process. As a precursor, RP (5 g, 99.998%, Alfa Aesar) was put into a stainless steel vial with two stainless steel balls (diameter: 12.7 mm) and was ground for 5 minutes to obtain RP powder. Then, Sn metal powder (99.995%, Alfa Aesar) was added into the vial by various Sn contents (1 wt %, 1.5 wt %, 2 wt %, 5 wt %, and 10 wt %). A second milling process was performed for 4 hours. To avoid synthesis of WP, grinding was controlled to be performed for 20 minutes at 30-minute intervals. Because BP is very sensitive to oxygen and moisture, sample preparation and ball milling were all performed in a glove box filled with argon (Ar). The color of the powder was changed from red to black due to the milling process, which means BP was synthesized.

After the second milling process, the powder was moved to a carbon die (inner diameter: 10 mm) for a subsequent SPS process. A sintering chamber was vacuumed to a pressure of 1 Pa, and sintering was performed at 723K and 75 MPa for 5 minutes. A heating rate was 75 K/m in.

After the SPS process, the BP pellets were analyzed using a scanning electron microscope (SEM) (S-4800, Hitachi) and an energy dispersive X-ray spectrometer (EDX) (Bruker). Phases of the samples were analyzed using an X-ray diffractometer (XRD) (SmartLab, Rigaku). A spherical aberration (Cs)-corrected transmission electron microscope (Cs-TEM) was adopted to analyze microstructures. For electrical measurements, the sintered pellets were cut and abraded into a rectangular shape, and a 4-point configuration was used to remove contact resistance. Carrier concentrations and mobilities were determined using a hole measurement system at 300K.

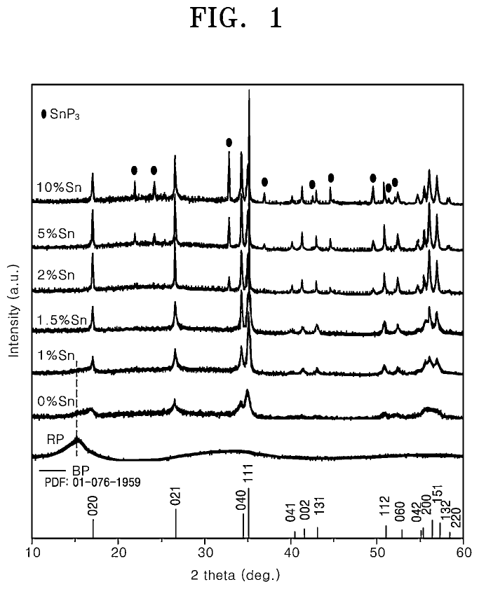

FIG. 1 shows XRD patterns of the sintered BP pellets based on various Sn contents. An XRD pattern of RP for comparison exhibits a wide background due to the amorphous structure of RP. The XRD pattern of the BP sample without Sn after the HEBM and SPS processes shows that orthorhombic BP is synthesized [JPDS No. 01-076-1959]. However, despite the additional grinding process, a background near 2θ=15.3° corresponding to amorphous RP still remains, which means that a certain amount of amorphous RP is still present in the sample.

Interestingly, a wide peak near 2θ=15.3° begins to be reduced when 1 wt % of Sn is added, and completely disappears when the Sn content is 1.5 wt %. Meanwhile, when the Sn content is increased, BP peaks become stronger and sharper. This implies that the addition of Sn facilitates transformation from RP into BP. When the Sn content reaches 2 wt %, the SnP₃ phase begins to appear in the XRD pattern.

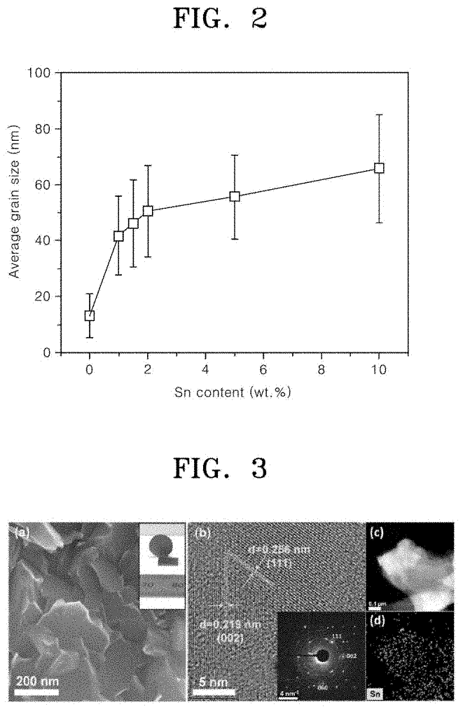

FIG. 2 is a graph showing average grain sizes of the sintered BP samples having various Sn contents after the SPS process. The average grain size of each sample was estimated using the Scherrer equation based on full width at half maximum (FWHM) values of XRD peaks. The BP sample containing no Sn (Sn content: 0 wt %) exhibits a minimum grain size of 13.3 nm, and the BP sample containing 10 wt % of Sn has grown to a grain size of 65.8 nm during the same SPS process.

It is understood that, when the Sn content is less than 2 wt %, BP forms a solid solution which contains a Sn solute in a BP matrix. When the content of dissolved Sn reaches 2 wt %, precipitation of SnP₃ begins to occur. Although the solubility of Sn in P is not accurately known due to sublimation of P, considering overall observation, the solubility of Sn in the BP matrix may be estimated to be about 2 wt %.

FIG. 3 shows results of analyzing the shape, microstructure, and chemical composition of the BP sample in which 1.5 wt % of Sn is dissolved, and includes (a) a SEM image of a fracture surface with an image of the BP sample after being cut and abraded, (b) a high-resolution transmission electron microscope (HR-TEM) image showing a lattice spacing and a diffraction pattern of BP, (c) a scanning transmission electron microscope (STEM) image of Sn, and (d) an EDX elemental map corresponding to Sn.

Specifically, (a) of FIG. 3 is a SEM image of a fracture surface of the BP pellet containing 1.5 wt % of Sn. The BP pellet exhibits a polycrystalline structure, and a density thereof is calculated to be 2.49 gcm⁻³ corresponding to 92.5% of a theoretical density (i.e., 2.69 gcm⁻³). When the Sn content is increased from 0 wt % to 10 wt %, as shown in Table 1, the density is increased from 2.24 gcm⁻³ to 2.81 gcm⁻³. Table 1 shows experimental densities of the sintered samples.

TABLE 1

| | |
|---|---|
| Samples | Experimental density (g/cm³) |

| | | |
|---|---|---|
| 0 | wt. % Sn | 2.24 |
| 1 | wt. % Sn | 2.36 |
| 1.5 | wt. % Sn | 2.49 |
| 2 | wt. % Sn | 2.56 |
| 5 | wt. % Sn | 2.68 |
| 10 | wt. % Sn | 2.81 |

(b) of FIG. 3 is a HR-TEM image of the BP pellet having a selected area electron diffraction (SAED) pattern corresponding to 1.5 wt % of Sn. D-spacing values of 0.256 nm and 0.219 nm are respectively indexed as (111) and (002) of BP.

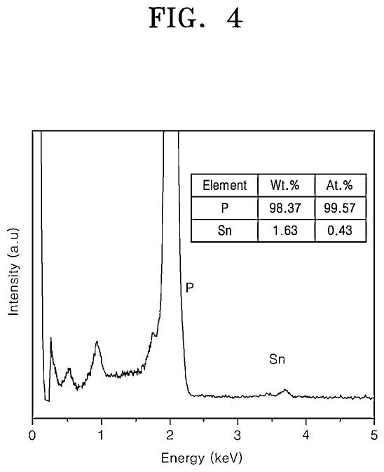

(c) and (d) of FIG. 3 are a STEM image and an EDX elemental map of Sn. It is shown that Sn is well dispersed throughout the BP matrix without agglomeration. This also reflects that BP forms a solid solution having a Sn content less than 2 wt %. An atomic ratio of Sn to P is determined to be about 1.6 wt % throughout the sample, which is consistent with the loaded amount of 1.5 wt % (see FIG. 4).

An RP phase remaining in a BP matrix may be observed regardless of a grinding time. However, in the present invention, when the Sn content is increased, the peak of amorphous RP is gradually weakened and disappears from the XRD pattern (see FIG. 1).

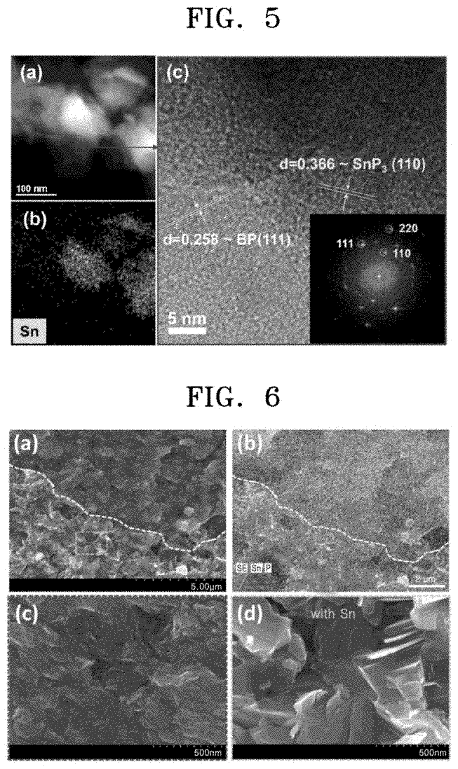

In addition, when the Sn content reaches 2 wt %, precipitation of SnP₃ randomly occurs in the BP matrix. An average grain size of SnP₃ is observed to be about 100 nm (see FIG. 5).

In solid-state reaction, a metal element may be often used as a catalyst for promoting phase transformation. Particularly, Sn is understood as being essential to the growth of BP crystals. For example, in a chemical vapor transport method, synthesis of a Sn—P—I compound may provide nucleation sites for the growth of BP.

In the experimental example of the present invention, the SPS process was performed at a vacuum pressure of 1 Pa and a temperature of 723K. An internal pressure of the carbon die used for SPS was assumed to be similar to the chamber pressure (i.e., 1 Pa) due to high porosity of compressed powder. Under the above-described condition, the sintering temperature is higher than or equal to a eutectic temperature (<714K) in a Sn—P phase diagram. Therefore, it is reasonably inferred that Sn may form a molten alloy with P at 723K. Because RP is less stable than BP due to the amorphous structure thereof, Sn forms a molten alloy preferentially with amorphous RP to remove RP. At the same time, P atoms in the molten alloy are supplied to adjacent BP grains for the growth of the grains until amorphous RP is exhausted. As a result, the BP grain size greatly varies depending on the Sn content (see FIG. 2).

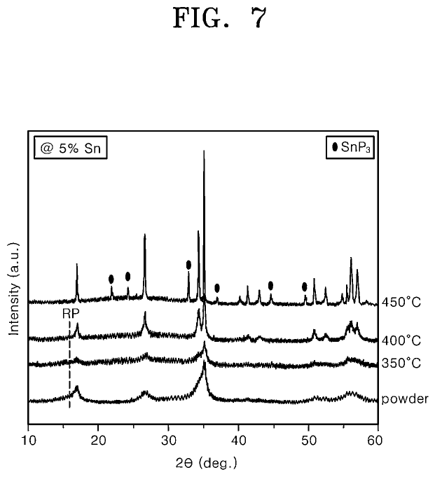

To clarify the role of Sn in RP-BP transformation, ground RP powder was mixed with Sn grains without HEBM and was sintered under the same SPS condition. As predicted, crystalline BP is observed in a Sn-rich region, but amorphous RP still remains when no Sn is present (see FIG. 6). For reference, an upper dashed rectangular region in (a) of FIG. 6 is magnified as shown in (c) of FIG. 6 and a lower dashed rectangular region in (a) of FIG. 6 is magnified as shown in (d) of FIG. 6. XRD patterns of pellets sintered at lower temperatures (e.g., 623K and 673K) where Sn may not form a molten alloy also exhibit weak BP peaks and remaining RP peaks (see FIG. 7).

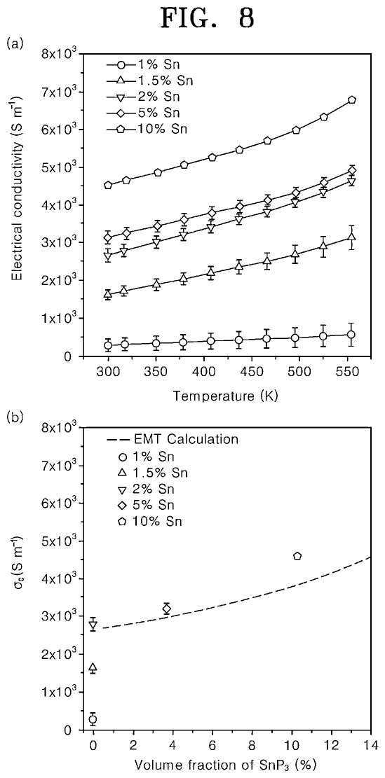

(a) of FIG. 8 shows electrical conductivities of BP pellets based on Sn contents at temperatures from 300K to 553K. Considering sublimation of P, the measurements were performed at 553K or below. An electrical conductivity a of bulk BP synthesized using the Bridgman method is known to be 100 Sm⁻¹ at 300K. A resistance of BP without Sn is too high to be measured using the measurement system of the current experimental example. However, the electrical conductivity is meaningfully increased in proportion to the Sn content. When the Sn content is gradually increased to 1 wt %, 1.5 wt %, 2 wt %, 5 wt %, and 10 wt %, the electrical conductivity at 300K is respectively increased to 280 Sm⁻¹, 1625 Sm⁻¹, 2662 Sm⁻¹, 3136 Sm⁻¹, and 4513 Sm⁻¹. The temperature-dependent electrical conductivity exhibits a semiconductor behavior. In all BP samples having various Sn contents, a is increased in proportion to the temperature.

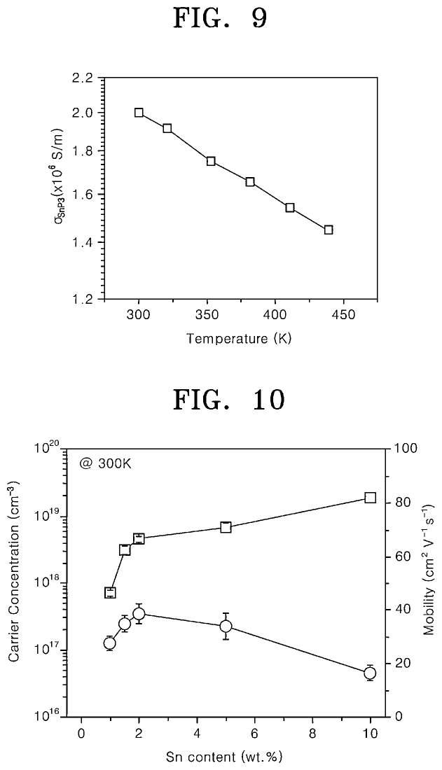

The effective medium theory (EMT) may be used to explain charge transportation in a composite material of BP and SnP₃. An effective electrical conductivity of the BP/SnP₃ composite may be calculated as shown below.

$$( 1 - V ) \frac{{σ}_{BP} - {σ}_{C}}{{σ}_{BP} + 2 {σ}_{C}} + V \frac{{σ}_{{S}_{n} {P}_{3}} - {σ}_{C}}{{σ}_{{S}_{n} {P}_{3}} + 2 {σ}_{C}} = 0 ,$$

where σ_{BP}, σ_{Snp3}, σ_{c} and V denote electrical conductivities of BP, SnP₃, and the composite, and a volume fraction of SnP₃ in the composite. For calculation, assuming a solubility of Sn (2 wt %) in a BP matrix, a of BP having a Sn content of 2 wt % is used as GBP. Unlike BP, SnP₃ exhibits a high electrical conductivity of 2×10⁶ Sm⁻¹ at 300K and shows a metal band structure in which the electrical conductivity is reduced when the temperature is increased (see FIG. 9). The volume fraction of SnP₃ was calculated on the assumption that an excessive amount of Sn was completely consumed to form SnP₃. The calculation result (EMT Calculation) is shown in (b) of FIG. 8 together with the measurement data of the current experimental example.

Interestingly, the measurement result of the current experimental example is very consistent with the prediction of the composite model having a Sn content of 2 wt %. However, the increase in electrical conductivity when the Sn content is less than or equal to 2 wt % may not be explained by the above model. When the amount of Sn in the BP matrix is increased, the electrical conductivity is increased without forming the SnP₃ phase. It may be understood that Sn may serve as a p-type dopant in the BP system to increase a carrier concentration.

Hole measurements were performed to better understand variations of a carrier concentration. A carrier mobility was evaluated using the relationship of σ=nqμ, where n, q, and p denote a carrier concentration, charge in electron units, and a charge mobility. FIG. 10 shows variations of a carrier concentration and a mobility based on a Sn content at 300K. For reference, data shown by rectangles indicates the carrier concentration, and data shown by circles indicates the mobility. When the Sn content is increased from 1 wt % to 2 wt %, the carrier concentration is rapidly increased from 7×10¹⁷ cm⁻³ to 4×10¹⁸ cm⁻³. Considering that the carrier concentration of pristine BP is 10¹⁵ cm⁻³ to 10¹⁷ cm⁻³, the carrier concentration is increased more than 10 times due to Sn doping. When the Sn content is further increased, the carrier concentration of the BP sample having a Sn content of 10 wt % is gradually increased to 1.9×10¹⁹ cm⁻³. A crossover of hole concentration increase rates occurs near the Sn content of 2 wt %, which reflects the doping effect (<2 wt %) and formation of the BP/SnP₃ composite 2 wt %). The carrier mobility is increased from 27 cm²V⁻¹s⁻¹ to 39 cm²V⁻¹s⁻¹ when the Sn content is increased from 1 wt % to 2 wt %, and then is gradually reduced to 17 cm²V⁻¹s⁻¹.

The rapid increase of the carrier mobility is due to formation of the crystalline BP phase as well as reduction of the amorphous RP phase. The gradual reduction of the mobility may relate to boundary scattering caused by the randomly dispersed SnP₃ phase which begins to precipitate from 2 wt % of Sn. Therefore, Sn serves as a p-type dopant which assists with phase transformation from amorphous RP into crystalline BP and, at the same time, increases the electrical conductivity of BP before the SnP₃ phase begins to precipitate after Sn is excessively added.

In short, Sn-doped bulk BP was synthesized using a ball milling process and a SPS process. Sn may be added to BP by 2 wt % or less as a p-type dopant, which increases an electrical conductivity by increasing a hole concentration and a mobility. When the Sn content reaches a solubility limit of 2 wt %, precipitation of SnP₃ occurs and thus a BP/SnP₃ composite is formed. The Sn-assisted crystallization method is expected to be used for low-cost mass production of BP with a high electrical conductivity.

One of the features of the present invention is to synthesize BP with a high purity (i.e., without RP). The RP is removed in a sintering process subsequent to a milling process, and formation of a melt phase is critical at this time. The sintering temperature is, for example, 450° C. and Sn forms a liquid phase at this temperature. A eutectic point in a phase diagram may vary depending on a pressure. Meanwhile, an element which exhibits a behavior similar to Sn may include thallium (TI). In a TI-P phase diagram, TI exhibits a eutectic point of 418° C. at normal pressure and thus may be regarded as being capable of removing RP based on formation of a melt phase.

While the present invention has been particularly shown and described with reference to embodiments thereof, it will be understood by one of ordinary skill in the art that various changes in form and details may be made therein without departing from the scope of the present invention as defined by the following claims.

1. A method of synthesizing black phosphorus (BP) by adding tin (Sn) while performing a milling process and a sintering process on red phosphorus (RP).

2. The method of claim 1, wherein Sn is added before the sintering process, and a sintering temperature of the sintering process is higher than or equal to a eutectic temperature of Sn and phosphorus (P).

3. The method of claim 2, wherein a purity of BP is relatively increased by an amount of Sn preferentially reacting with RP rather than BP in a molten alloy of Sn and P formed in the sintering process.

4. The method of claim 1, wherein Sn serves as a dopant in BP to relatively increase an electrical conductivity of BP in proportion to a carrier concentration.

5. The method of claim 4, wherein, when Sn is added by 1.5 wt %, RP is completely crystallized into Sn-doped BP and an electrical conductivity of Sn-doped BP is more than 16 times higher than an electrical conductivity of pristine BP.

6. The method of claim 1, wherein, when a content of added Sn exceeds a solubility of Sn dissolved in a BP matrix, an electrical conductivity of a composite of the BP matrix and a SnP₃ precipitate precipitated in the BP matrix is relatively higher than the electrical conductivity of pristine BP.

7. The method of claim 1, wherein, when a content of added Sn is increased from 1 wt % to 10 wt %, an electrical conductivity of synthesized BP at 300K to 553K is increased.

8. The method of claim 1, wherein the milling process comprises a high energy ball milling (HEBM) process, and the sintering process comprises a spark plasma sintering (SPS) process.
